(19) United States
(12) Patent Application Publication
(10) Pub. No.: US 2025/0060102 A1
(43) Pub. Date: Feb. 20, 2025

(54) GLOW PLUG WITH AN EXPOSED FILAMENT AND AN INSERT AND MOUNTING ARRANGEMENT INCLUDING THE SAME

(71) Applicant: Robert Bosch Limitada, Campinas - SP (BR)

(72) Inventors: Fernando Lepsch, Campinas SP (BR); Andrei Montanha Buzete, Campinas – SP (BR); Renato de Brito Duenhas, Paulínia - SP (BR)

(21) Appl. No.: 18/721,395

(22) PCT Filed: Dec. 20, 2022
(86) PCT No.: PCT/BR2022/050512

§ 371 Date: Sep. 5, 2024

(30) Foreign Application Priority Data
Dec. 21, 2021 (BR) 1020210259965

(51) Int. Cl. F23Q 7/00; F02M 31/125; F02M 53/02; H05B 3/06

(52) U.S. Cl. CPC F23Q 7/001; F02M 31/125; F02M 53/02; H05B 3/06

(57) ABSTRACT

The present invention refers to a heating plug, more particularly, a heating plug containing an exposed filament, which is used in fuel galleries, principally those applied in internal combustion engines requiring fuel heating. The heating plug with exposed filament provided with an insert, said heating plug including a shell (10), which encloses, inside, at least one electrical terminal (20); at least one filament support (60); and at least one filament (70) in electrical contact with said at least one electrical terminal (20) by means of at least one pin (50). The present invention provides a sufficiently robust, efficient and reliable solution which does not demand altering all the constructive arrangement of the heating plug, which is capable of assuring adequate sealing between the fuel gallery and the heating plug and which, moreover, guarantees the correct power supply to the exposed filament.

### BACKGROUND

The present invention refers to a heating plug, more particularly, a heating plug containing an exposed filament, which is used in fuel galleries, principally those applied in internal combustion engines requiring fuel heating.

Internal combustion engines are thermal machines, commonly associated to automobiles, which convert the thermal energy resulting from combustion of a fuel into mechanical energy.

In the past, vehicles with bifuel engines (ethanol and gasoline, for example) needed an additional dedicated fuel tank for initial injection of gasoline, due to the fact that ethanol has a low vaporization content, chiefly in low temperature conditions.

With the aim of eliminating the additional gasoline tank, various cold-start devices have been developed to assist with the combustion process, among which are heating plugs or fuel pre-heating.

The heating plug is the device responsible for supplying heat to the fuel to be pre-heated. Therefore, the combustion chamber is powered with heated fuel, which increases the efficiency of the combustion of the gases inside it.

Usually, the plugs are assembled on the heating chambers and have heating lances which are introduced therein, so efficient sealing is thus needed between said heating plugs and respective heating chambers.

A first example of heating plug used in fuel galleries is described in document BRMU9002503, and same includes a body supportive to a thermal lance (built-in electrical resistance in a casing) and to a connector, said heating plug being positioned inside a heating chamber, so as to be used both as heating element of the fuel, and sealing element of the heating chamber. The electrical connector of the heating plug of this document is made by overmolding and same is adapted to be fastened in plastic fuel galleries, this fastening being carried out by a clip.

A second example of heating plug is described in document BR202016019239 which, in turn, describes a heating plug with exposed filament that comprises: a shell 1′, preferably plastic, the inside of which contains electrical components, and the filament 7′ remains in electrical contact with at least one electrical terminal 2′, and a filament support 6′ (comprised of a support rod and a support base) is fastened to one of the ends 11′ of the shell, promoting electric communication between the electrical components contained inside the shell 1′ and the filament 7′ which extends in the opposite direction to the shell 1′, being directly exposed to the fuel, and between at least two electrical components and the coupling orifices 12′ at least two sealing rings 4′ (o'rings) are provided. The material of the shell 1′ and of the elements of the filament support 6′ are made of plastic, while the sealing rings 4′ are made of rubber.

Regarding the assembly of the heating plug of the document BR202016019239 next to the fuel gallery, said heating plug is introduced into an orifice of the gallery whose inner diameter is lower than the outer diameter of the ring 3′ and, accordingly, the fitting between the plug and the gallery is by pressure, because, by the fact that the outer diameter of the ring 3′ is greater than the inner diameter of the orifice of the gallery, there is a deformation of the ring 3′. With this, there is no gap at all in the sealing region between the plug and the gallery preventing the flow of fuel to the outside environment.

Moreover, electrical connectors are provided, inserted into the pins 5′, so as to electrically connect the ends of the filament 7′ to electrical terminals 2′ present inside the shell. Since this plug contains two electrical terminals 2′ for supplying electric energy to the filament 7′, the need is gone to use metal material in the shell 1′, since it is no longer responsible for the electrical earthing. However, for this to be possible, the shell 1′ is comprised of insulating material, for example, plastic, so that the electrical terminals 2′ inside it are insulated. The disposition of the electrical terminals 2′ is carried out in a way so as to permit one of the ends to be connected to an electric plug (not illustrated) originating from the vehicle's electrical system and the other end to the electrical connectors present in the pins 5′.

For the coupling of each of the pins 5′ on the shell 1′ coupling orifices 12′ are provided, and the inner sealing of the shell 1′ is carried out by way of sealing rings 4′. Similarly to the outer sealing, the outer diameter on the sealing ring 4′ is larger than the inner diameter of the coupling orifice 12′ and, against, the fitting is by pressure, as there is an elastic deformation between the sealing ring 4′ and the interior of the coupling orifice 12′. The sealing of the pins 5′ bars the flow of fuel inside the shell 1′ and prevents contact of the fuel, which has highly corrosive characteristics, with the internal elements of the heating plug.

Since the filament 7′ is exposed to fuel, this solution brought substantial improvements, as it significantly increased the efficiency of the heat exchange between the filament 7′ and the fuel, besides decreasing the time necessary for pre-heating the filament 7′. Further, the elimination of metal components according to the prior art also caused a decrease in the weight of the product and, consequently, made it possible to dispense with robust mechanical structures for filing of the gallery in the motor. However, it is noted that in the solution of this document, the sealing between the heating plug and the fuel gallery is given by plastic parts.

However, and due to the growth of the use of Otto cycle engines that use high pressure fuel injection system (over 100 bar), there is the need to install a fuel heating system capable of withstanding and working under said pressures.

Currently, the high performance heaters available (exposed filament), according to BR202016019239, only work with low pressure systems (approximately 4 bar) and cannot withstand high pressure, precisely because the sealing referred to is by plastic parts. The plastic material is sufficiently robust for low pressure systems, but lacks sufficient mechanical resistance to withstand high pressure, since its mechanical properties are reduced due to permeation of the fuel in the plastic by high pressure action and continuous use, making it lose its function of resisting the pressure of the fuel during the course of its life.

The heaters based on the heating plug, according to document BRMU9002503, could withstand the high pressure, but do not have the heating performance generated by the heater with exposed filament.

Accordingly, and although the solutions described above prove functional for the objectives for which they were intended, it is noted that there are still gaps in the state of the art with reference to the provision of a solution sufficiently robust, efficient and reliable, which does not demand altering all the construction arrangement of the heating plug, that is capable of assuring adequate sealing between the fuel gallery and the heating plug and that, further, guarantees correct power supply for the exposed filament. The present invention is intended to provide an improvement to the solution described in document BR202016019239.

It is based on this scenario that the invention in question arises.

### SUMMARY

Accordingly, it is an underlying objective of the invention in question to disclose a heating plug with exposed filament provided with an insert, applicable to internal combustion engines;

More specifically, it is an objective of the present invention to describe a sufficiently robust, efficient and reliable solution relative to fuel heating plugs, preferably;

Further, it is an objective of the present invention to present a solution capable of assuring adequate sealing between the fuel gallery and the heating plug and which, moreover, guarantees the correct power supply to the exposed filament;

Another objective is to describe a simple, low-cost and practical solution, applicable to already devised fuel heating systems;

In other words, it is an objective of the present invention to devise a solution that allows the retrofitting of systems already validated and currently produced;

Put otherwise, it is an objective of the present invention to provide an improvement to the solution described in document BR202016019239.

The objectives summarized above are achieved by means of a heating plug with exposed filament provided with an insert, said heating plug including a shell, which encloses, inside, at least one electrical terminal; at least one filament support; and at least one filament in electrical contact with said at least one electrical terminal by means of at least one pin, and said heating plug includes at least one insert; said shell comprises an assembly portion; said assembly portion cooperates with said at least one insert; said at least one insert comprises at least one coupling orifice capable of receiving said at least one pin; said filament support resting against an anterior portion of the at least one insert; and, at least said anterior portion of the at least one insert is made of metal material.

Preferably, said at least one insert is made wholly of metal. More preferably, there is provided at least one spacer on the interface between said at least one pin and respective at least one coupling orifice. Also preferably, said at least one spacer is a separate part relative to the other components. Alternatively, said at least one spacer is made in a single part with the filament support, extending from a support base thereof.

Still preferably, said pin comprises a circumferential recess where said at least one spacer is assembled. Also preferably, said at least one spacer is juxtaposed to a respective inner sealing ring which, in turn, also makes the interface between respective at least one coupling orifice of the at least one insert and respective pin.

According to the preferred embodiment of the invention, said assembly portion further comprises at least one first assembly element capable of cooperating with a second assembly element provided on said at least one insert.

The present invention also refers to the assembly arrangement including heating plug with exposed filament provided with an insert, as previously described, said assembly arrangement including a fuel gallery comprising gallery walls which define an inner space and at least one opening next to which a heating plug with the filament support is assembled extending inwardly of the inner space, said assembly arrangement further including at least one outer sealing ring, and the insert is disposed, at least partially, in the inner space of the fuel gallery and the shell is disposed outwardly of the fuel gallery.

According to this arrangement, it is the pair of at least one outer sealing ring and said at least one insert that provides the sealing of the fuel gallery.

According to an embodiment of the invention, said assembly portion defines at least one step, said at least one insert defines at least one insert flange, and at least one assembly clip rests against said at least one step and said at least one insert flange and said at least one outer sealing ring rests against said at least one insert flange.

### BRIEF DESCRIPTION OF THE DRAWINGS

The invention in question will now be described in greater detail, based on the illustrative drawings listed below:

FIG. 1 illustrates a blown-up perspective view of a heating plug with exposed filament, like the one of document BR202016019239;

FIG. 2 illustrates a blown-up perspective view of a heating plug with exposed filament provided with an insert, according to the present invention;

FIG. 3 illustrates a cutaway view of the heating plug with exposed filament provided with an insert, according to the present invention;

FIG. 4 illustrates another cutaway view of a hypothetical heating plug without spacers, illustrating the undesirable electrical short-circuit;

FIG. 5 illustrates the same cutaway view as FIG. 4, but with a heating plug being provided with spacers to assure the correct power supply, according to the present invention;

FIG. 6 illustrates a heating plug with exposed filament provided with an insert, according to an alternative of the present invention;

FIG. 7 illustrates an assembly arrangement including a heating plug with exposed filament provided with an insert, according to the present invention.

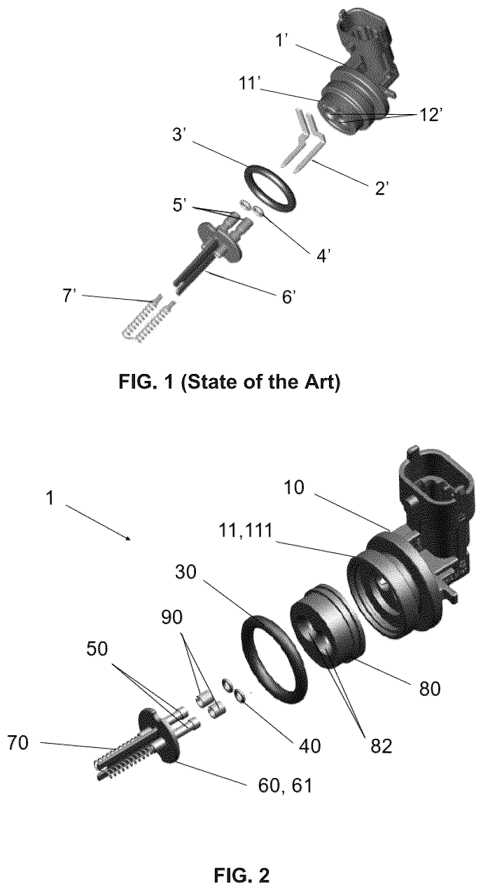

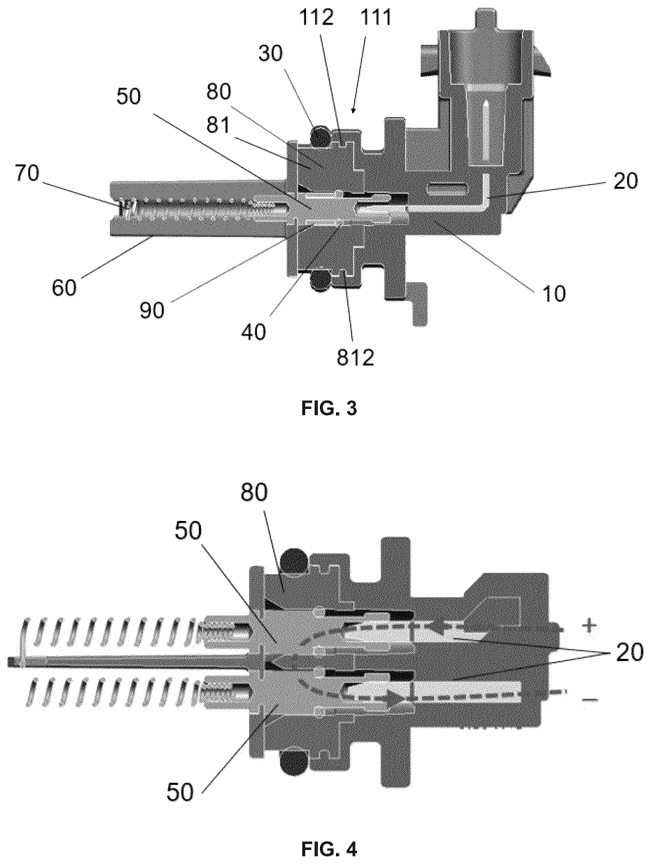

### DETAILED DESCRIPTION

The present invention refers to a heating plug with exposed filament provided with an insert, said heating plug including a shell 10, preferably plastic, which encloses, inside, at least one electrical terminal 20; at least one filament support 60; at least one filament 70 in electrical contact with said at least one electrical terminal 20 by means of at least one pin 50.

In particular, according to the present invention, said heating plug 1 includes at least one insert 80; said shell 10 comprises an assembly portion 11 which cooperates with said at least one insert 80, so as to receive it and embrace it by means of an assembly portion flange 111; said at least one insert 80 comprises at least one coupling orifice 12 capable of receiving said at least one pin 50; said filament support 60 resting against an anterior portion 81 of the at least one insert 80; and at least said anterior portion 81 of the at least one insert 80 is made of metal material.

Preferably, the insert 80 is made wholly of metal. Also preferably, said assembly portion 11 further comprises at least one first assembly element 112 capable of cooperating with a second assembly element 812 provided on said at least one insert 80, to carry out adequate assembly and safe fastening between said components. More preferably, said shell 10 is over-injected in at least one insert 80.

Here, it is appropriate to highlight that said filament 70 refers to a filament of electrical resistance, to provide the fuel heating by Joule effect. It must also be underlined that the first assembly element and the second assembly element 111, 112 can be ledges and recesses or vice-versa, provided that one is the counter part of the other.

The provision of this insert 80 with at least one metal portion guarantees that the portion of the heating plug 1 which is found inside the fuel gallery 90 is sufficiently robust to withstand the high fuel pressures inside thereof and guarantee adequate sealing of the set.

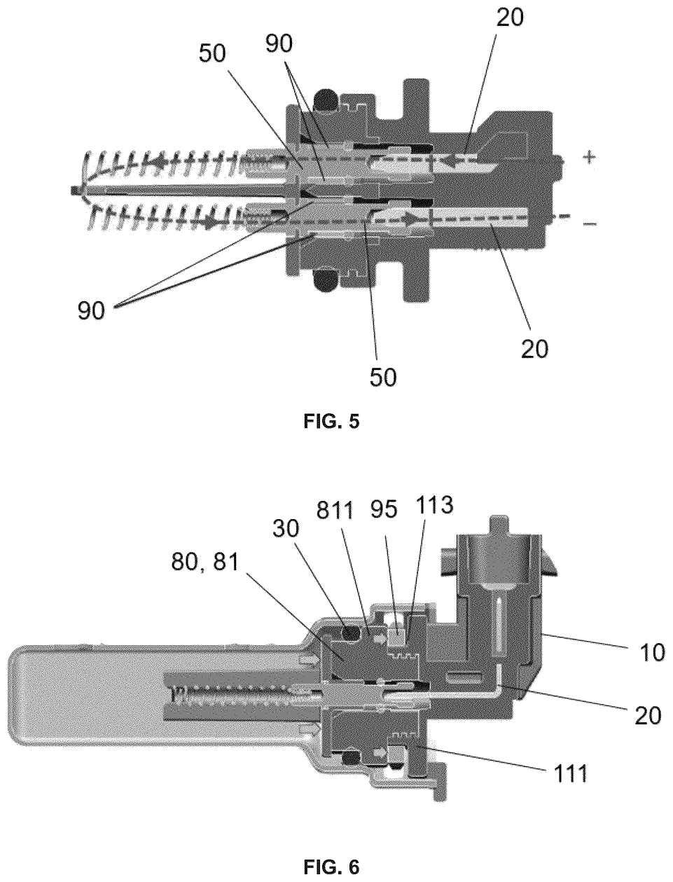

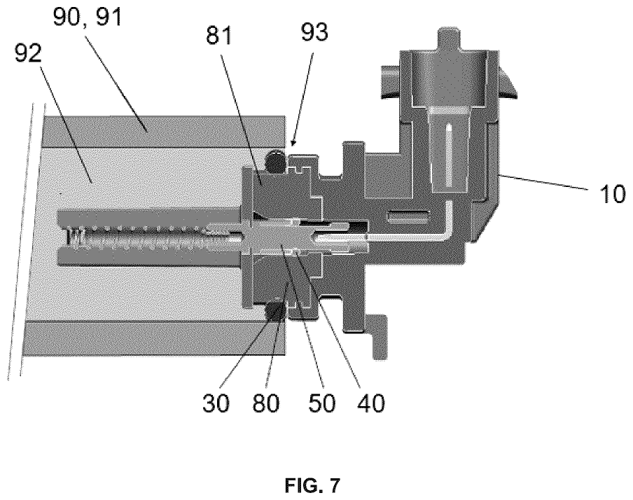

Having solved the problem relative to the sealing of the set, by means of the provision of said at least one insert 80 with at least one metal portion, a new problem arises, precisely based on the metal material of the insert 80, namely, the electric conductivity for the filament 70. This is because since said insert 80 involves, by means of respective coupling orifices 82, respective pins 50, the electrical current may sustain a short-circuit, as illustrated by the arrows in FIG. 4, crossing the electrical terminals 20 to the pins 50, to the insert 80, back to the pins 50 and back to the electrical terminals 20, without arriving at the filament 70, which is extremely undesirable. This is why it is compulsory to electrically insulate said insert 80, so that the electrical current is conducted by the adequate path, as illustrated by the arrows in FIG. 5.

Accordingly, said heating plug with exposed filament provided with an insert, according to the present invention further includes at least one spacer 90 on the interface between said at least one pin 50 and respective at least one coupling orifice 82. Said at least one spacer 90 is assembled on the outer face of the respective pin 50 and makes the interface with the inner face of the respective coupling orifice 82.

According to the preferred embodiment of the present invention, said spacer 90 is juxtaposed to a respective inner sealing ring 40 which, in turn, also makes the interface between respective at least one coupling orifice 82 of the at least one insert 80 and respective pin 50.

The outer diameter of the inner sealing ring 40 is larger than the inner diameter of the respective coupling orifice 82 and the fitting is by pressure, since there is an elastic deformation between the inner sealing ring 40 and the inside of the coupling orifice 82. The sealing of the pins 50 bars the flow of fuel inside the shell 10 and prevents contact of the fuel, which has highly corrosive characteristics, with the internal elements of the heating plug 1.

Also preferably, said spacer 90 is made of non-conductive material, for example, plastic, rubber, glass or ceramic and has a tubular shape. Also preferably, said at least one spacer 90 is a separate part relative to the other components.

Alternatively, said at least one spacer 90 can be made in a single part with the filament support 60, extending from a support base 61 thereof.

Optionally, said at least one pin 50 comprises a circumferential recess 51 where said at least one spacer 90 is assembled.

Having described the constructivity of the heating plug 1 in and of itself, below is a description of the assembly arrangement including heating plug with exposed filament provided with an insert, such as the present invention.

Said assembly arrangement includes a fuel gallery 90 comprising gallery walls 91 that define an inner space 92 and at least one opening 93 next to which there is mounted a heating plug 1 with the filament support 60 extending inwardly of the inner space 92, said assembly arrangement further including at least one outer sealing ring 30, and said at least one insert 80 is disposed, at least partially, in the inner space 92 of the fuel gallery 90.

According to the arrangement of the present invention, the shell 10 is disposed outwardly of the fuel gallery 90, such that it is the pair formed by at least one outer sealing ring 30 and said at least one insert 80 that provides the sealing of the fuel gallery 90. The outer sealing ring 30 is preferably made of rubber.

The inner diameter of the opening 93 of the fuel gallery 90 (defined by the gallery walls 91) is smaller than the outer diameter of the outer sealing ring 30 and, accordingly, the fitting between the heating plug 1 and the fuel gallery 90 is by pressure, because, due to the fact that the outer diameter of the outer sealing ring 30 is larger than the inner diameter of the opening 93 of the fuel gallery 90, there is a deformation of the outer sealing ring 30. With this, there is no gap at all in the sealing region between the plug and the gallery preventing the flow of fuel to the outside environment.

Further, according to an alternative of the present invention, said assembly portion 11 define at least one step 113, said at least one insert 80 defines at least one insert flange 811, and at least one assembly clip 95 rests against said at least one step 113 and said at least one insert flange 811 and said at least one outer sealing ring 30 rests against said at least one insert flange 811.

According to this alternative, when the fuel exerts pressure/force on the support base 61 of the filament support 60, the latter presses the insert 80 which, in turn, presses the assembly clip 95 against the shell 10.

It is important to underline that the description above has the sole objective of describing an exemplary embodiment particular of the invention in question. Therefore, it is clear that modifications, variations and constructive combinations of the elements that exert the same function substantially in the same way to achieve the same results, continue to be within the scope of protection defined by the accompanying claims.

1. A heating plug with exposed filament provided with an insert, said heating plug including a shell (10), which encloses, inside, at least one electrical terminal (20); at least one filament support (60); and at least one filament (70) in electrical contact with said at least one electrical terminal (20) by at least one pin (50), wherein:
said heating plug (1) includes at least one insert (80);
said shell (10) comprises an assembly portion (11);
said assembly portion (11) cooperates with said at least one insert (80);
said at least one insert (80) comprises at least one coupling orifice (82) capable of receiving said at least one pin (50);
said filament support (60) resting against an anterior portion (81) of the at least one insert (80);
and, at least said anterior portion (81) of the at least one insert (80) is made of metal material.

2. The heating plug with exposed filament provided with an insert, according to claim 1, wherein said at least one insert (80) is made wholly of metal.

3. The heating plug with exposed filament provided with an insert, according to claim 1, further comprising at least one spacer (90) in an interface between said at least one pin (50) and a respective one of the at least one coupling orifice (82).

4. The heating plug with exposed filament provided with an insert, according to claim 3, wherein said at least one spacer (90) is a separate part relative to the other components.

5. The heating plug with exposed filament provided with an insert, according to claim 3, wherein said at least one spacer (90) is made in a single part with the filament support (60), extending from a support base (61) thereof.

6. The heating plug with exposed filament provided with an insert, according to claim 1, wherein said at least one pin (50) comprises a circumferential recess (51) where said at least one spacer (90) is assembled.

7. The heating plug with exposed filament provided with an insert, according to claim 3, wherein said at least one spacer (90) is juxtaposed to a respective inner sealing ring (40) which, in turn, also makes the interface between the at least one coupling orifice (82) of the at least one insert (80) and the respective one of the least one pin (50).

8. The heating plug with exposed filament provided with an insert, according to claim 1, wherein said assembly portion (11) further comprises at least one first assembly element (112) capable of cooperating with a second assembly element (812) provided in said at least one insert (80).

9. An assembly arrangement including heating plug with exposed filament provided with an insert, as defined in claim 1, including a fuel gallery (90) comprising gallery walls (91) which define an inner space (92) and at least one opening (93) next to which the heating plug (1) with the filament support (60) is assembled, extending inwardly of the inner space (92), said assembly arrangement further including at least one outer sealing ring (30), wherein the insert (80) is disposed, at least partially, in the inner space (92) of the fuel gallery (90).

10. The assembly arrangement including heating plug with exposed filament provided with an insert, according to claim 9, wherein the shell (10) is disposed outwardly of the fuel gallery (90).

11. The assembly arrangement including heating plug with exposed filament provided with an insert, according to claim 9, wherein a combination of at least one outer sealing ring (30) and said at least one insert (80) provides a sealing of the fuel gallery (90).

12. The assembly arrangement including heating plug with exposed filament provided with an insert, according to claim 9, wherein said assembly portion (11) defines at least one step (113), said at least one insert (80) defines at least one insert flange (811), and at least one assembly clip rests against said at least one step (113) and said at least one insert flange (811) and at least one outer sealing ring (30) rests against said at least one insert flange (811).
